(19) United States
(12) Patent Application Publication
(10) Pub. No.: US 2026/0204557 A1
(43) Pub. Date: Jul. 16, 2026

(54) LITHIUM NICKEL-BASED COMPOSITE OXIDE AS A POSITIVE ELECTRODE ACTIVE MATERIAL FOR SULFIDE SOLID-STATE RECHARGEABLE BATTERIES

(71) Applicant: Umicore, Brussels (BE)

(72) Inventors: Shinichi KUMAKURA, Olen (BE); TaeHyeon YANG, Chungcheongnam-do (KR); JiHoon KANG, Chungcheongnam-do (KR); KunWoo YOO, Chungcheongnam-do (KR); YunSeop LEE, Chungcheongnam-do (KR)

(21) Appl. No.: 19/134,353

(22) PCT Filed: Dec. 7, 2023
(86) PCT No.: PCT/EP2023/084658

§ 371 Date: May 30, 2025

(30) Foreign Application Priority Data
Dec. 8, 2022 (EP) 22212280.6
Dec. 8, 2022 (EP) 22212289.7

(51) Int. Cl. H01M 4/525; C01G 53/504; H01M 10/0562; H01M 50/431

(52) U.S. Cl. CPC H01M 4/525; C01G 53/504; H01M 10/0562; H01M 50/431; C01P 2002/54; C01P 2002/85; C01P 2004/03; C01P 2004/61; C01P 2004/62; C01P 2006/40; H01M 2300/0068

(57) ABSTRACT

The present invention relates to a positive electrode active material, comprising Li, M′, and oxygen, wherein M′ comprises Ni, Co, Mn, B Q, wherein Q is an element other than Li, O, Ni, Co, Mn, and B and wherein the positive electrode active material has an enriched amount of B in the surface layer and wherein said positive electrode active material comprises secondary particles comprising a plurality of primary particles having a low crystallite size.

### TECHNICAL FIELD

The present invention relates to a positive electrode active material for solid state batteries comprising Li, M′ and O, wherein M′ comprises B. This invention also relates to a method for manufacturing said positive electrode active material, the solid-state battery comprising said positive electrode active material and the use of said solid-state battery.

### BACKGROUND

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to the high energy density and a high reference electrode potential.

During the charging process of a secondary battery, lithium ions are removed from the cathode, transported through the electrolyte and are inserted into the anode while electrons are removed from the cathode and injected into the anode through an external circuit (charger). During the use or discharge of a secondary battery lithium ions are removed from the anode, transported through the electrolyte, and are inserted into the cathode, while electrons flow through an external circuit to provide electric work.

Commonly used cathode active materials are lithium transition metal oxides. During the charging and/or discharging of the lithium, battery, the delithiated cathode active material can slowly react with the non-aqueous electrolyte or the solid electrolyte leading to a gradual degradation of the electrochemical performance of lithium batteries using such cathode active materials. It has been demonstrated that coating of the cathode active material with metals, such as B or Zr, (i.e. applying a thin surface layer of the metal on the cathode active material resulting in an increased amount of said metals in the surface layer) results in a cathode active material exhibiting a higher stability as compared to their counterparts devoid of coating layer.

US 2020/0303720 A1 contemplates a boron coated positive electrode active material including nickel, cobalt and manganese in a ratio 8:1:1 by dry-mixing said uncoated positive electrode active material with boron, followed by a heat treatment step of 300° C. for 5 hours.

Zhang et al (Adv. Energy Mater. 2020, 10, 1903778) describes a boron coated positive electrode active material including nickel, cobalt and manganese in a ratio 5:2:3 using a sol-gel method, wherein triisopropyl borate was dissolved in ethanol and said uncoated positive electrode active material was then dispersed in said solution followed by removal of the solvent and subsequent heat treatment at 350° C.

However, there remains a need to provide a positive electrode active material having an enriched amount of boron in the surface layer to improve the cycling efficiency of the resulting battery and/or reduce the polarization of the battery as much as possible.

It is an object of the present invention to provide a positive electrode active material having an enriched amount of boron in the surface layer, which improves the cycling efficiency of the resulting battery.

It is another object of the present invention to provide a method for manufacturing said positive electrode active material.

It is another object of the present invention to provide a battery comprising said positive electrode active material.

It is another object of the present invention to provide a use of said battery.

### SUMMARY OF THE INVENTION

In a first aspect an object of the invention is achieved by providing a positive electrode active material for solid state batteries, comprising Li, M′, and oxygen, wherein M′ comprises:
Ni in a content x, wherein 50.0≤x≤75.0 mol %, relative to M′,
Co in a content y, wherein 0.0≤y≤25.0 mol %, relative to M′,
Mn in a content z, wherein 0.0≤z≤25.0 mol %, relative to M′,
B in a content b, wherein 0.01≤b≤1.5 mol %, relative to M′,
Q in a content q, wherein Q is an element other than Li, O, Ni, Co, Mn, and B, wherein 0.0≤q≤2.0 mol %, relative to M′, and,
wherein x, y, z, b, and q are measured by ICP-OES,
wherein x+y+z+b+q is 100.0 mol %,
   wherein the positive electrode active material has an enriched amount of B in the surface layer, and
   wherein said positive electrode active material comprises secondary particles comprising a plurality of primary particles having a low crystallite size.

The present inventors have surprisingly found that the positive electrode active material of the invention increases the cycling efficiency of the battery, in particular of a sulfide solid-state battery, significantly. Moreover, this positive electrode active material displays a low polarization in the battery.

Without wishing to be bound by any theory, the present inventors believe that the combination of the enriched amount of B in the surface layer (i.e. a boron coating) with a positive electrode active material having a low crystallite size (i.e. secondary particle comprising primary particles have an average diameter of between 100 nm to 400 nm) enhances the cycling efficiency of the battery and/or reduces the polarization in the battery.

Although boron coated positive electrode active materials are already known in the art (see US 2020/0303720 A1 or Zhang et al (Adv. Energy Mater. 2020, 10, 1903778)), the present inventors are the first one to report on the synergistic effect of the boron coating with the low crystallite size of the positive electrode active material. US 2020/0303720 A1 or Zhang et al (Adv. Energy Mater. 2020, 10, 1903778) neither disclose the crystallize size of the particles nor describe or suggest the synergistic effect of the boron coating with the low crystallize size of the particles.

In a further aspect the invention provides a method for manufacturing said positive electrode active material.

In a further aspect the invention provides a battery comprising said positive electrode active material.

In a further aspect the invention provides a use of said battery.

### FIGURES

FIG. 1. XPS spectrum of B1s peak for EX1.1.

FIG. 2a. SEM image showing a secondary particle of CEX1 comprising plurality of primary particles, wherein dotted line shows the area to be captured in order to obtain the average primary particle diameter.

FIG. 2b. SEM image of CEX1 to obtain the average primary particle diameter.

### DETAILED DESCRIPTION OF THE INVENTION

In the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein and in the claims refers to a cell or a battery that includes only solid or substantially solid-state components such as solid electrodes (e.g. anode and cathode) and a solid electrolyte.

The term “a positive electrode active material” (also known as cathode active material) as used herein and in the claims is defined as a material which is electrochemically active in a positive electrode or cathode. By active material, it must be understood to be a material capable to capture and release Li ions when subjected to a voltage change over a predetermined period of time.

In the context of the present invention the terms “solid” and “liquid” shall be considered to be a solid and liquid in standard conditions for temperature and pressure as defined by the IUPAC, unless defined otherwise. Hereby the boiling point and the melting point shall be considered to be the boiling point and the melting point at standard atmospheric pressure, i.e. at 101325 Pa.

### Positive Electrode Active Material

In a first aspect the present invention concerns a positive electrode active material for solid state batteries comprising Li, M′, and oxygen, wherein M′ comprises:
Ni in a content x, wherein 50.0<x≤75.0 mol %, relative to M′,
Co in a content y, wherein 0.0≤y≤25.0 mol %, relative to M′,
Mn in a content z, wherein 0.0≤z≤25.0 mol %, relative to M′,
B in a content b, wherein 0.01≤b≤2.0 mol %, relative to M′, preferably wherein 0.01≤b≤1.5 mol %, relative to M′,
Q in a content q, wherein Q is an element other than Li, O, Ni, Co, Mn, and B, wherein 0.0≤q≤2.0 mol %, relative to M′, and,
wherein x, y, z, b, and q are measured by ICP-OES,
wherein x+y+z+b+q is 100.0 mol %,
   wherein the positive electrode active material has a B content B_{A} defined as b/(x+y+z+b), wherein the positive electrode active material has a B content B_{B} wherein B_{B} is determined by XPS analysis, wherein B_{B} is expressed as molar fraction B compared to the sum of molar fractions of Ni, Mn, Co, and B, as measured by XPS analysis, wherein the ratio B_{B}/B_{A}>40.0, preferably wherein the ratio B_{B}/B_{A}>45.0, wherein said positive electrode active material comprises secondary particles comprising a plurality of primary particles, wherein said primary particles have an average diameter of between 100 nm to 400 nm as determined by measuring primary particle size in an image taken by SEM.

A preferred embodiment is the positive electrode active material of the invention, wherein Ni is in a content x≥55.0 mol %, preferably x≥58.0 mol %, more preferably x≥60.0 mol %. In a preferred embodiment Ni is in a content x≤70.0 mol % preferably x≤68.0 mol % and more preferably x≤65.0 mol %. A more preferred embodiment is the positive electrode active material of the invention, wherein Ni is in a content x between 55.0 mol %≤x≤70.0 mol %, preferably 58.0 mol %≤x≤68.0 mol %, more preferably 60.0 mol %≤x≤65.0 mol %.

As appreciated by the skilled person the amount of Li and M′, preferably Li, Ni, Mn, Co, Q and B in the positive electrode active material is measured by Inductively Coupled Plasma Optical Emission Spectroscopy (ICP-OES). For example, but not limiting to the invention, an Agilent ICP 720-ES is used in the ICP-OES analysis.

A preferred embodiment is the positive electrode active material of the invention, wherein Co is in a content y>0.0 mol %, preferably y≥10.0 mol %, more preferably y≥18.0 mol %. In a preferred embodiment the content is y≤28.0 mol %, preferably y≤25.0 mol %, and more preferably y≤22.0 mol %. In a preferred embodiment Mn is in a content 0.0 mol %<y≤28.0 mol %, preferably 10.0 mol %≤y≤25.0 mol %, more preferably 18.0 mol %≤y≤22.0 mol %.

A preferred embodiment is the positive electrode active material of the invention, wherein Mn is in a content z>0.0 mol %, preferably z≥10.0 mol %, more preferably z≥15.0 mol %. In a preferred embodiment the content is z≤28.0 mol %, preferably z≤25.0 mol %, and more preferably z≤20.0 mol %. In a preferred embodiment Mn is in a content 0.0 mol %<z≤28.0 mol %, preferably 10.0 mol %≤z≤25.0 mol %, more preferably 15.0 mol %≤z≤20.0 mol %.

As is known to the skilled person, the positive electrode active material of the invention can comprise impurities or be doped or coated resulting in an overall positive electrode active material comprising one or more elements other than Li, Ni, Mn, Co, B and O, which is reflected in the parameter “Q” used herein. A preferred embodiment is the positive electrode active material according to the invention comprising Q, wherein Q is at least one element selected from the group consisting of Al, Ti, Ba, Ca, Cr, Fe, Mg, Mo, Nb, S, Si, Sr, V, W, Y, Zn, and Zr; preferably Al, Ti, Cr, Nb, S, Si, Y, Zr and W; more preferably Al, Ti, Nb, Zr and W.

A preferred embodiment is the positive electrode active material according to the invention, wherein Q is in q content q>0.0 mol %, preferably q≥0.25 mol %, more preferably q≥0.5 mol %. In a preferred embodiment the content q≤1.75 mol %, preferably q≤1.5 mol %, more preferably q≤1.25 mol %. In a preferred embodiment the content is 0.0 mol %<q≤1.75 mol %, preferably 0.25 mol %≤q≤1.5 mol %, more preferably 0.5 mol %≤q≤1.25 mol %.

In certain preferred embodiments the positive electrode active material is according to the invention, wherein q=0.0 mol %.

A preferred embodiment is the positive electrode active material of the invention, wherein B is in a content b≥0.05 mol %, preferably b≥0.1 mol %, more preferably b≥0.2 mol %. In a preferred embodiment b≤1.25 mol %, preferably b≤1.1 mol %, more preferably b≤1.0 mol %. In a preferred embodiment 0.05 mol %≤b≤1.25 mol %, preferably 0.1 mol %≤b≤1.1 mol %, more preferably 0.2 mol %≤b≤1.0 mol %.

A preferred embodiment is the positive electrode active material of the invention having a Li/M′ ratio, preferably a Li/(Ni+Mn+Co) ratio, >0.90, preferably >0.92, more preferably >0.95. A preferred embodiment is the positive electrode active material of the invention having a Li/M′ ratio, preferably a Li/(Ni+Mn+Co) ratio, <1.10, preferably <1.08, more preferably <1.05. A preferred embodiment is the positive electrode active material of the invention having a Li/M′ ratio, preferably a Li/(Ni+Mn+Co) ratio, in the range of 0.90-1.10, preferably in the range of 0.92-1.08, more preferably in the range of 0.95-1.05. As appreciated by the skilled person the Li/M′ ratio, preferably the Li/(Ni+Mn+Co) ratio, is a molar ratio (mol/mol).

A preferred embodiment is the positive electrode active material of the invention having a carbon content of higher than 0.010 wt. % by total weight of the positive electrode active material, preferably a carbon content higher than 0.011 wt. %, more preferably a carbon content higher than 0.012 wt. % by total weight of the positive electrode active material. A preferred embodiment is the positive electrode active material of the invention having a carbon content of less than 0.050 wt. % by total weight of the positive electrode active material, preferably a carbon content less than 0.040 wt. %, more preferably a carbon content less than 0.030 wt. % by total weight of the positive electrode active material. A preferred embodiment is the positive electrode active material of the invention having a carbon content in the range of 0.010 wt. % and 0.050 wt. % by total weight of the positive electrode active material, preferably a carbon content in the range of 0.011 wt. % and 0.040 wt. %, more preferably a carbon content in the range of 0.012 wt. % 0.030 wt. % by total weight of the positive electrode active material. As appreciated by the skilled person the carbon content of the positive electrode active material of the invention is measured with a carbon analyzer. For example, but not limiting to the invention, a Horiba Emia-Expert carbon/sulfur analyzer can be used to measure the carbon content C.

A highly preferred embodiment is the positive electrode active material according to the invention having a formula (I):

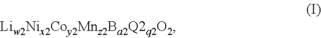

wherein 0.90≤w2≤1.10, preferably 0.92≤w2≤1.08, more preferably 0.95≤w2≤1.05;
wherein 0.50≤x2≤0.75, preferably 0.55≤x2≤0.70, more preferably 0.60≤x2≤0.65;
wherein 0.0<y2≤0.28, preferably 0.10≤y2≤0.25, more preferably 0.18≤y2≤0.22;
wherein 0.0<z2≤0.28, preferably 0.10≤z2≤0.25, more preferably 0.15≤z2≤0.20;
wherein 0.0005≤b2≤0.0125, preferably 0.001≤b2≤0.011, more preferably 0.002≤b2≤0.01;
wherein 0.0≤q2≤0.0175, preferably 0.0≤q2≤0.015, more preferably 0.0≤q2≤0.0125, most preferably q2 is about 0.0;
wherein x2+y2+z2+b2+q2=1.00; and
wherein Q2 is an element other than Li, O, Ni, Co, Mn and B.

As is known to the skilled person, the positive electrode active material of the invention can comprise impurities or be doped or coated resulting in an overall positive electrode active material comprising one or more elements other than Li, Ni, Mn, Co, B and O, which is reflected in the parameter “Q2” used herein. A preferred embodiment is the positive electrode active material according to the invention comprising Q2, wherein Q2 is at least one element selected from the group consisting of Al, Ti, Ba, Ca, Cr, Fe, Mg, Mo, Nb, S, Si, Sr, V, W, Y, Zn, and Zr; preferably Al, Ti, Cr, Nb, S, Si, Y, Zr and W; more preferably Al, Ti, Nb, Zr and W.

### Surface Layer

A preferred embodiment concerns the positive electrode active material of the invention, wherein the positive electrode active material has a B content B_{A} defined as b/(x+y+z+b), wherein the positive electrode active material has a B content B_{B} wherein B_{B} is determined by XPS analysis, wherein B_{B} is expressed as molar fraction B compared to the sum of molar fractions of Ni, Mn, Co, and B, as measured by XPS analysis, wherein the ratio B_{B}/B_{A}>40.0.

A more preferred embodiment concerns the positive electrode active material of the invention wherein the ratio B_{B}/B_{A}>45.0, preferably the ratio B_{B}/B_{A}>50.0, more preferably the ratio B_{B}/B_{A}>60.0, even more preferably the ratio B_{B}/B_{A}>70.0, even more preferably the ratio B_{B}/B_{A}>80.0, most preferably the ratio B_{B}/B_{A}>90.0.

A more preferred embodiment concerns the positive electrode active material of the invention wherein the ratio B_{B}/B_{A}<1000.0, preferably the ratio B_{B}/B_{A}<500.0, more preferably the ratio B_{B}/B_{A}<200.0, even more preferably the ratio B_{B}/B_{A}<150.0, most preferably the ratio B_{B}/B_{A}<125.0.

A more preferred embodiment concerns the positive electrode active material of the invention, wherein the ratio B_{B}/B_{A} is in the range of 50.0 and 1000.0, preferably the ratio B_{B}/B_{A} is in the range of 70.0 and 200.0, more preferably the ratio B_{B}/B_{A} is in the range of 90.0 and 125.0.

In the context of the present invention, B_{B} is the molar fraction B compared to the sum of molar fractions of Ni, Mn, Co, and B, wherein the molar fraction of B measured in a region of a particle of the positive electrode active material according to invention defined between a first point of an external edge of said particle and a second point at a distance from said first point. Said distance separating said first to said second point being equal to a penetration depth of said XPS, said penetration depth D′ being comprised between 1.0 to 10.0 nm. In particular, the penetration depth is the distance along an axis perpendicular to a virtu-al line tangent to said external edge and passing trough said first point. As appreciated by the skilled person a similar XPS analysis is conducted for the molar fraction of Ni, Mn and Co.

The external edge of the particle is, in the framework of this invention, the boundary or external limit distinguishing the particle from its external environment. Therefore, XPS analysis provides atomic content of elements in an uppermost layer of a particle with a penetration depth of about 10.0 nm from an outer boundary of the particle. The outer boundary of the particle is also referred to as “surface”. For example, but not limiting to the invention, XPS analysis is carried out with a Thermo K-α+ spectrometer (Thermo Scientific).

In the framework of the present invention, at % signifies atomic percentage. The at % or “atomic percent” of a given element expression of a concentration means how many percent of all atoms in the concerned compound are atoms of said element. Further in the framework of the present invention the designation at % is equivalent to mol % or “molar percent”.

In the context of the present invention the positive electrode active material may comprise a further surface layer comprising Q, wherein Q is at least one element selected from the group consisting of Al, Ti, Ba, Ca, Cr, Fe, Mg, Mo, Nb, S, Si, Sr, V, W, Y, Zn, and Zr; preferably Al, Ti, Cr, Nb, S, Si, Y, Zr and W; more preferably Al, Ti, Nb, Zr and W, wherein the surface layer of B may be placed on the further surface layer and/or the further surface layer may be placed on the surface layer of B and/or the positive electrode active material may comprise a mixed surface layer comprising the surface layer of B and the further surface layer.

### Morphology

In a preferred embodiment, said positive electrode active material of the invention comprises polycrystalline particles comprising a plurality of primary particles. As appreciated by the skilled person the polycrystalline particles are agglomerated by 5 or more single-crystalline particles, preferably 10 or more single-crystalline particles, more preferably 50 or more single-crystalline particles. This can be observed in proper microscope techniques like Scanning Electron Microscope (SEM) by observing grain boundaries. Agglomeration of the single-crystalline particles to the polycrystalline particles occurs under a post-treatment step such as a thermal treatment step. In the context of the present invention a particle is considered to be single-crystalline if it consists of only one grain or at most five grains, preferably at most three grains, as observed by Scanning Electron Microscope (SEM) or Transmission Electron Microscope (TEM), preferably by observing grain boundaries of the particle. A grain boundary is defined as the interface between two grains in a particle, preferably wherein the atomic planes of the two grains are aligned to different orientations and meet as a crystalline discontinuity.

Preferred embodiments concern the positive electrode active material of the invention comprising polycrystalline particles having a secondary particle median D50 value of less than 20 μm, preferably less than 15 μm, more preferably less than 12 μm. Preferred embodiments concern the positive electrode active material of the invention comprising polycrystalline particles having a secondary particle median D50 value of more than 2 μm, preferably more than 5 μm, more preferably more than 8 μm. Preferred embodiments concern the positive electrode active material of the invention comprising polycrystalline particles having a secondary particle median D50 value between 2 and 20 μm, preferably between 5 and 15 μm, more preferably between 8 and 12 μm. As appreciated by the skilled person the particle size distribution (PSD) D50 of the positive electrode active material powder is measured by laser diffraction particle size analysis. For example, but not limiting to the invention, the particle median D50 can be measured using a Malvern Mastersizer 3000. In a highly preferred embodiment the particle size distribution (PSD) of the polycrystalline particles comprised in the positive electrode active material of the invention is measured by a secondary particle size analysis method, preferably wherein the particle size distribution (PSD) of the positive electrode active material is measured by laser diffraction particle size analysis using a Malvern Mastersizer 3000 with a Hydro MV wet dispersion accessory after having dispersed each of the powder samples in an aqueous medium. More preferably, D50 is defined as the particle size at 50% of the cumulative volume % distributions obtained from the Malvern Mastersizer 3000 with Hydro MV measurements.

In certain preferred embodiments of the invention and in the context of the present invention the polycrystalline particle as defined herein is a secondary particle. As appreciated by the skilled person in these certain preferred embodiments all embodiments related to the polycrystalline particle equally apply to the secondary particle as defined in the present invention.

In a preferred embodiment, said positive electrode active material of the invention comprises polycrystalline particles comprising a plurality of primary particles, said primary particles have an average diameter of between 100 nm to 400 nm as determined by measuring primary particle size in an image taken by SEM. Preferred embodiments concern the positive electrode active material of the invention comprising polycrystalline particles comprising a plurality of primary particles, wherein said primary particles have an average diameter of more than 150 nm, preferably more than 200 nm, more preferably more than 250 nm. Preferred embodiments concern the positive electrode active material of the invention comprising polycrystalline particles comprising a plurality of primary particles, wherein said primary particles have an average diameter of less than 375 nm, preferably less than 350 nm, more preferably less than 325 nm. Preferred embodiments concern the positive electrode active material of the invention comprising polycrystalline particles comprising a plurality of primary particles, wherein said primary particles have an average diameter of between 150 and 375 nm, preferably between 200 and 350 nm, more preferably between 250 and 325 nm. In a highly preferred embodiment the average diameter of the primary particle is measured by a primary particle size analysis method, preferably by measuring primary particle size in an image taken by SEM. As understood by the skilled person the average diameter of the primary particle is measured by the primary particle size analysis method, wherein the diameter of primary particle is calculated by using ImageJ software (ImageJ 1.52a, National Institutes of Health, USA) according to the following steps:
Step 1) Open the file containing SEM image of positive electrode active material with 10,000 times magnification wherein the image is taken at the center part of a secondary particle.
Step 2) Set scale according to the SEM magnification.
Step 3) Draw lines following primary particle edges using ‘polygon selections’ tool for at least 50 particles. The particles at the edges of image are to be excluded if truncated.
Step 4) Measure the area of the drawn primary particles selected from Set Measurements and Area box.
Step 5) Calculated the particle diameter of each measured area by assuming the particle in the spherical shape following

$$d = 2 \times \sqrt{\frac{area}{π}}$$

and obtain the average primary particle diameter for at least 50 particles.

As appreciated by the skilled person and in highly preferred embodiments of the invention the secondary particles comprise the B content B_{A} as defined herein, the B content B_{B} as defined herein and said ratio B_{B}/B_{A} as defined herein.

In certain preferred embodiments of the invention the positive electrode active material of the invention comprises polycrystalline particles comprising a plurality of primary particles, wherein,
the polycrystalline particles have a secondary particle median D50 value between 12 and 20 μm, preferably between 5 and 15 μm, more preferably between 8 and 12 μm, and
the primary particles have an average diameter of between 150 and 375 nm, preferably between 200 and 350 nm, more preferably between 250 and 325 nm.

In certain preferred embodiments of the invention the positive electrode active material of the invention comprises polycrystalline particles comprising a plurality of primary particles, wherein,
the polycrystalline particles have a secondary particle median D50 value between 12 and 20 μm, preferably between 5 and 15 μm, more preferably between 8 and 12 μm, and
the ratio B_{B}/B_{A} is in the range of 50.0 and 1000.0, preferably the ratio B_{B}/B_{A} is in the range of 70.0 and 200.0, more preferably the ratio B_{B}/B_{A} is in the range of 90.0 and 125.0.

In certain preferred embodiments of the invention the positive electrode active material of the invention comprises polycrystalline particles comprising a plurality of primary particles, wherein
the primary particles have an average diameter of between 150 and 375 nm, preferably between 200 and 350 nm, more preferably between 250 and 325 nm, and
the ratio B_{B}/B_{A} is in the range of 50.0 and 1000.0, preferably the ratio B_{B}/B_{A} is in the range of 70.0 and 200.0, more preferably the ratio B_{B}/B_{A} is in the range of 90.0 and 125.0.

In preferred embodiments of the invention the positive electrode active material of the invention comprises polycrystalline particles comprising a plurality of primary particles, wherein
the polycrystalline particles have a secondary particle median D50 value between 12 and 20 μm, preferably between 5 and 15 μm, more preferably between 8 and 12 μm,
the primary particles have an average diameter of between 150 and 375 nm, preferably between 200 and 350 nm, more preferably between 250 and 325 nm, and
the ratio B_{B}/B_{A} is in the range of 50.0 and 1000.0, preferably the ratio B_{B}/B_{A} is in the range of 70.0 and 200.0, more preferably the ratio B_{B}/B_{A} is in the range of 90.0 and 125.0

In a further aspect the invention provides a secondary particles-based positive electrode active material for solid state batteries comprising Li, M′, and oxygen, wherein M′ comprises:
Ni in a content x, wherein 50.0≤x≤75.0 mol %, relative to M′,
Co in a content y, wherein 0.0≤y≤30.0 mol %, relative to M′,
Mn in a content z, wherein 0.0≤z≤30.0 mol %, relative to M′,
B in a content b, wherein 0.01≤b≤1.5 mol %, relative to M′,
Q in a content q, wherein Q is an element other than Li, O, Ni, Co, Mn and B, wherein 0.0≤q≤2.0 mol %, relative to M′, and,
wherein x, y, z, b, and q are measured by ICP-OES,
wherein x+y+z+b+q is 100.0 mol %,
wherein the positive electrode active material has a B content B_{A} defined as b/(x+y+z+b),
   wherein the positive electrode active material has a B content B_{B}, wherein B_{B} is determined by XPS analysis, wherein B_{B} is expressed as molar fraction B compared to the sum of molar fractions of Ni, Mn, Co, and B, as measured by XPS analysis, wherein the ratio B_{B}/B_{A}>40.0, wherein said secondary particles comprises a plurality of primary particles, and wherein said primary particles have an average diameter of between 100 nm to 400 nm as determined by measuring primary particle size in an image taken by SEM.

In a highly preferred embodiment of the secondary particles-based positive electrode active material, all embodiments directed to the positive electrode active material according to the first aspect of the invention apply mutatis mutandis to the secondary particles-based positive electrode active material. For example, the various embodiments relating to the identity and amounts of Li, M′, B_{B}, B_{A}, primary and secondary particle size as explained herein in the context of the positive electrode active material are equally applicable to the secondary particles-based positive electrode active material.

### Method

In a second aspect the invention provides a method for manufacturing a positive electrode active material, wherein said method comprises:
preparing a lithium transition metal-based oxide compound,
mixing said lithium transition metal-based oxide compound with a B source so as to obtain a mixture, and
heating the mixture at a temperature between 250° C. and less than 500° C. for a time between 1 hour and 20 hours so as to obtain the positive electrode active material.

In a highly preferred embodiment of the method for manufacturing a positive electrode active material of the invention the positive electrode active material is according to the first aspect of the invention. As appreciated by the skilled person, in case the method for manufacturing a positive electrode active material of the invention affords the positive electrode material according to the first aspect of the invention, all embodiments directed to the positive electrode active material according to the first aspect of the invention apply mutatis mutandis to the method for manufacturing the positive electrode active material according to the first aspect of the invention. For example, the various embodiments relating to the identity and amounts of Li, M′, B_{B}, B_{A}, primary and secondary particle size as explained herein in the context of the positive electrode active material are equally applicable to the method for the preparation of the positive electrode active material.

In a preferred embodiment of the method the lithium transition metal-based oxide compound comprising Li, M″ and oxygen, wherein M″ comprises Ni, Mn, Co and Q, wherein Q is at least one element of the group consisting of: Al, Ti, Ba, Ca, Cr, Fe, Mg, Mo, Nb, S, Si, Sr, V, W, Y, Zn, and Zr; preferably Al, Ti, Cr, Nb, S, Si, Y, Zr and W; more preferably Al, Ti, Nb, Zr and W. Preferably, the lithium transition metal-based oxide used is also typically prepared according to a lithiation process, which is the process wherein a mixture of a transition metal oxide precursor and a source of lithium is heated at a temperature preferably of at least 500° C. and at most 1000° C. Typically, the transition metal precursor is prepared by coprecipitation of one or more transition metal sources, such as salts, preferably sulfates or nitrates, more preferably sulfates; of the elements Ni, Mn and/or Co, in the presence of an alkali compound, such as an alkali hydroxide e.g. sodium hydroxide and/or ammonia. Preferably, the source of lithium is metallic lithium or a lithium salt, preferably a lithium salt such as LiOH.

In a preferred embodiment mixing said lithium transition metal-based oxide compound with a B source is dry-mixing of said lithium transition metal-based oxide compound with a B source. As appreciated by the skilled person dry-mixing means that no additional solvent is added to the mixture of the lithium transition metal-based oxide compound and the B source.

In a preferred embodiment the B source is boric acid (H₃BO₃), boron oxide (B₂O₃) or a borate salt such as sodium tetrahydroxyborate (NaB(OH)₄), trisodium orthoborate (Na₃BO₃), sodium perborate (Na₂H₄B₂O₈), sodium meta borate (Na₃B₃O₆) and the like, preferably the B source is boric acid (H₃BO₃).

In a preferred embodiment the amount of B source added is at least 0.05 mol % mol % B present in the B source relative to M″, preferably at least 0.1 mol %, more preferably at least 0.2 mol % B present in the B source relative to M″. In a preferred embodiment the amount of B source added is at most 1.25 mol % mol % B present in the B source relative to M″, preferably at most 1.1 mol %, more preferably at most 1.0 mol % B present in the B source relative to M′. In a preferred embodiment the amount of B source added is between 0.05 mol % and 1.25 mol % B present in the B source relative to M″, preferably between 0.1 mol % and 1.1 mol %, more preferably between 0.2 mol % and 1.0 mol % B present in the B source relative to M″.

In a preferred embodiment of the method the heating of the mixture is at a temperature of more than 275° C., preferably more than 300° C., most preferably more than 325° C. In a preferred embodiment of the method the heating of the mixture is a temperature of less than 450° C., preferably less than 400° C., more preferably less than 375° C. In a preferred embodiment of the method the heating of the mixture is at a temperature between 275° C. and 450° C., preferably between 30° and 400° C., more preferably between 325 and 375° C.

In a preferred embodiment the heating of the mixture is at a time more than 2 hours, preferably more than 3 hours, more preferably more than 4 hours. In a preferred embodiment the heating of the mixture is at a time less than 15 hours, preferably less than 10 hours, preferably less than 7 hours. In a preferred embodiment the heating of the mixture is at a time between 2 hours and 15 hours, preferably between 3 hours and 12 hours, more preferably between 4 hours and 10 hours.

In a preferred embodiment the heating of the mixture is:
at a temperature between 275° C. and 450° C., preferably between 30° and 400° C., more preferably between 325 and 375° C.; and
at a time between 2 hours and 15 hours, preferably between 3 hours and 12 hours, more preferably between 4 hours and 10 hours.

A preferred embodiment of the method is the heating of the mixture under an oxidizing atmosphere. Preferably, the oxidizing atmosphere comprises oxygen, such as air, or consists of oxygen.

In a more preferred embodiment the heating occurs in a furnace.

### Product-by-Process

In a third aspect the invention concerns the positive electrode active material obtainable by the method according to the second aspect of the invention.

As appreciated by the skilled person all embodiments directed to the positive electrode active material according to the first aspect of the invention and/or the method according to the second aspect of the invention apply mutatis mutandis to the positive electrode active material obtainable by the method according to the invention. For example, the various embodiments relating to the identity and amounts of Li, M′, B_{B}, B_{A}, primary and secondary particle size as explained herein in the context of the positive electrode active material of the invention and/or in the context of the method of the invention are equally applicable to the positive electrode active material obtainable by the method for manufacturing the positive electrode active material.

### Battery

In a fourth aspect the invention concerns a battery comprising the positive electrode active material according to the first aspect of the invention and/or the positive electrode active material obtainable by the method according to the third aspect of the invention.

In a preferred embodiment the battery is a solid-state battery. Preferably the solid-state battery comprises a sulfide-based electrolyte. Preferably said electrolyte is a sulfide based solid electrolyte, more preferably the electrolyte comprises Li, P, and S. Typically, the following sulfur containing compounds of Li₆PS₅X with X being F, Br, Cl or I, preferably Br or Cl; thio-LISICON (Li_{3.25}Ge_{0.25}P_{0.75}S₄), Li₂S—P₂S₅—LiCl, Li₂S—SiS₂, LiI—Li₂S—SiS₂, Li₂S—P₂S₅—LiCl, Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—SiS₂, Li₃PO₄—Li₂S—SiS₂, Li₃PO₄—Li₂S—SiS₂, Li₁₀GeP₂S₁₂, Li_{9.54}Si_{1.74}P_{1.44}S_{11.7}Cl_{0.3}, and/or Li₇P₃S₁₁ may be suitably used. In a highly preferred embodiment the battery is a sulfide solid-state battery.

Preferably, the solid-state battery further comprises an anode comprising anode active material. Suitable electrochemically active anode materials are those known in the art. For example, the anode may comprise graphitic carbon, metallic lithium or a metal alloy comprising lithium, such as Li—In alloy, as the anode active material.

In a preferred embodiment the battery according to the invention has a rate efficiency of at least 85%, preferably at least 86%, more preferably at least 88%, most preferably at least 90%. As appreciated by the skilled person the rate efficiency of the battery is determined through the rate efficiency testing method, wherein the testing method is a conventional “constant cut-off voltage” test, wherein each cell is cycled at 60° C. using a Toscat-3100 computer-controlled galvanostatic cycling station (from Toyo). The rate efficiency (%) is obtained according to below an equation below wherein DQ5 is the discharge capacity at the fifth cycle:

$$Rate efficiency ( \% ) = \frac{D Q 5}{D Q 1} \times 100 ( \% ) .$$

Preferably, the schedule uses a 1 C current definition of 160 mA/g, the initial charge capacity (CQ1) and discharge capacity (DQ1) are measured in constant current mode (CC) at C rate of 0.1 C in voltage range from 4.3 V to 2.5 V (Li/Li⁺) or from 3.7 V to 1.9 V (In—Li/Li⁺).

In a preferred embodiment the battery according to the invention has a first discharge capacity of at least 180 mAh/g, more preferably of at least 182 mAh/g, most preferably of at least 190 mAh/g. As understood by the skilled person the first discharge capacity (DQ1) is measured in constant current mode (CC) at C rate of 0.1 C in voltage range: 4.3 V to 2.5 V (Li/Li⁺) or 3.7 V to 1.9 V (InLi/Li⁺).

In a preferred embodiment the battery according to the invention has an efficiency of at least 88%, preferably at least 90%, more preferably at least 92%, most preferably at least 94%. As appreciated by the skilled person the efficiency of the battery is determined, wherein the initial charge capacity (CQ1) and discharge capacity (DQ1) are measured in constant current mode (CC) at C rate of 0.1 C in voltage range from 4.3 V to 2.5 V (Li/Li⁺) or from 3.7 V to 1.9 V (In—Li/Li⁺). The efficiency (%) of the reversible capacity is obtained according to an equation below:

$$Efficiency ( \% ) = \frac{D Q 1}{C Q 1} \times 100 ( \% ) .$$

Preferably, the schedule uses a 1 C current definition of 160 mA/g.

In a preferred embodiment the battery according to the invention has a polarization (CV1-DV1) of less than 50 mV, preferably less than 40 mV, more preferably less than 35 mV. As appreciated by the skilled person the polarization of the battery is determined, wherein the difference between the average voltage of the initial charge (CV1) and the average voltage of the initial discharge (DV1) is used to decide the amount of polarization of the positive electrode:

$$Polarization value ( mV ) = CV 1 ( mV ) - DV 1 ( mV )$$

Preferably, to calculate CV1, a capacity in terms of power, in Watt-hours (Wh), is divided with CQ1 and the capacity in terms of power of the discharge in the first cycle (W_{C1}) is calculated from the area beneath the plotted graph of voltage (V) versus capacity (mAh/g). Preferably, DV1 is calculated by dividing the capacity in terms of power of the discharge in the first cycle (W_{D1}) with DQ1.

### Use

In a fifth aspect the present invention concerns a use of the positive electrode active material according to the first aspect of the invention and/or the positive electrode active material obtainable by the method according to the third aspect of the invention in a battery.

A preferred embodiment is the use of the positive electrode active material in a battery, preferably a solid-state-battery, more preferably a sulfide solid-state-battery, to increase the efficiency of the battery and/or to increase the first discharge capacity of said battery and/or to increase the rate efficiency of said battery and/or to decrease the polarization of said battery.

In a sixth aspect the present invention concerns a use of the battery according to invention in either one of a portable computer, a tablet, a mobile phone, an energy storage system, an electric vehicle or in a hybrid electric vehicle, preferably in an electric vehicle or in a hybrid electric vehicle.

### EXAMPLES

### Experimental Analysis Used in the Examples

The following analysis methods are used in the Examples.

### A) Inductively Coupled Plasma Optical Emission Spectrometry (ICP-OES) Measurement

The amount of Li, Ni, Co, Mn and B in the positive electrode active material powder is measured with the inductively coupled plasma-optical emission spectrometry (ICP-OES) method by using an Agillent ICP 720-ES (Agilent Technologies). 2 grams of powder sample is dissolved into 10 mL of high purity hydrochloric acid (at least 37 wt % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 ml volumetric flask. Afterwards, the volumetric flask is filled with deionized water up to the 250 ml mark, followed by complete homogenization.

### B) X-Ray Photoelectron Spectroscopy (XPS) Measurement

The surface of the positive electrode active material is analyzed by using X-ray photoelectron spectroscopy (XPS). In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of positive electrode active material powder particles, XPS measurement is carried out using a Thermo K-α+ spectrometer. Monochromatic Al Kα radiation (hv=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow-scans are performed afterwards at 50 eV for at least 10 scans for each identified element to determine the precise surface composition.

Curve fitting is done with CasaXPS Version2.3.19PR1.0 (Casa Software, using a Shirley-type background treatment and Scofield sensitivity factors. The fitting parameters are according to Table 1a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 1a
XPS fitting parameter for Ni2p, Mn2p, Co2p, and B1s.

| | Sensitivity | Fitting | | Line |
|---|---|---|---|---|
| Element | factor | range (eV) | Defined peak(s) | shape |
| Ni | 14.61 | 851.1 ± 0.1- | Ni2p3, Ni2p3 | LA(1.33, |
| | | 869.4 ± 0.1 | satellite | 2.44, 69) |
| Mn | 9.17 | 639.9 ± 0.1- | Mn2p3, Mn2p3 | GL(30) |
| | | 649.5 ± 0.1 | satellite | |
| Co | 12.62 | 775.4 ± 0.1- | Co2p3-1, Co2p3-2, | GL(30) |
| | | 792.7 ± 0.3 | Co2p3 satellite | |
| B | 0.49 | 186.0 ± 0.1- | B1s peak 1, | GL(30) |
| | | 196.3 ± 0.1 | B1s peak 2 | |

For Mn and Co peaks, constraints are set for each defined peak according to Table 1b.

TABLE 1b
XPS fitting Constraints for Mn2p and Co2p.

| | | Fitting range | FWHM | |
|---|---|---|---|---|
| | Defined | constraint | constraint | |
| Element | peak | (eV) | (eV) | Area constraint |
| Mn | Mn2p3 peak 1 | 640-642 | 0.1-3.5 | No constraint set |
| | Mn2p3 peak 1 | 642-644 | 0.1-3.5 | No constraint set |
| | Mn2p3 peak 2 | 644-646 | 0.1-3.5 | 40% of Mn2p3 |
| | satellite | | | peak 1 area |
| | Mn2p3 peak 2 | 645-650 | 0.1-3.5 | 40% of Mn2p3 |
| | satellite | | | peak 2 area |
| Co | Co2p3-1 | 776.0-780.9 | 0.5-4.0 | No constraint set |
| | Co2p3-2 | 781.0-785.0 | 0.5-4.0 | No constraint set |
| | Co2p3 satellite | 785.1-792.0 | 0.5-6.0 | No constraint set |

The B surface contents as determined by XPS is expressed as a molar fraction of B in the surface layer of the particles divided by the total content of Ni, Co, Mn, and B in said surface layer. It is calculated as follow:

$$Fraction of B = {B}_{B} = \frac{B ( a t \% )}{Ni ( a t \% ) + Co ( a t \% ) + Mn ( a t \% ) + B ( at \% )}$$

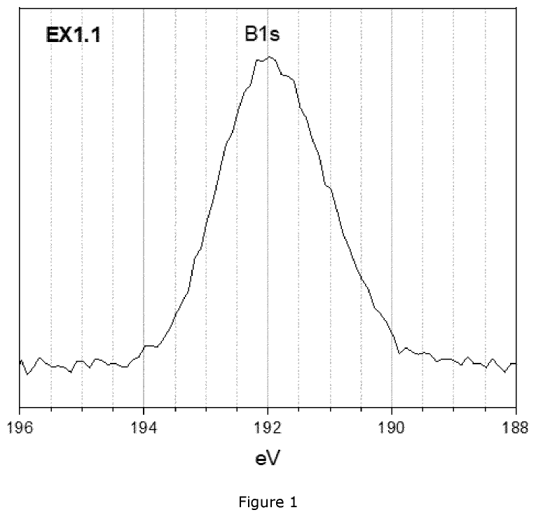

The information of XPS peak position can be easily obtained in the regions and components report specification after fitting is conducted. XPS graph of B for EX1 is shown in FIG. 1.

### C) Scanning Electron Microscope (SEM) Measurement

The morphology and the primary particle size of the positive electrode active material are analyzed by a scanning electron microscopy (SEM) technique. The measurement is performed with a JEOL JSM 7100F under a high vacuum environment of 9.6×10⁻⁵ Pa at 25° C.

### D) Particle Size

### D-1) Secondary Particle Size Analysis

The particle size distribution (PSD) of the positive electrode active material is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring are applied, and an appropriate surfactant is introduced. D50 is defined as the particle size at 50% of the cumulative volume % distributions obtained from the Malvern Mastersizer 3000 with Hydro MV measurements.

### D-2) Primary Particle Size Analysis

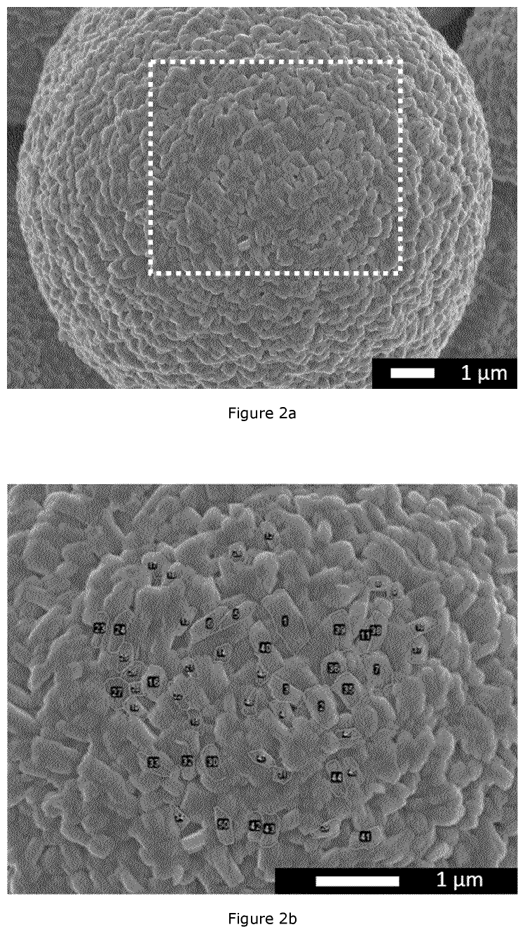

The diameter of primary particle is calculated by using ImageJ software (ImageJ 1.52a, National Institutes of Health, USA) according to the following steps:
Step 1) Open the file containing SEM image of positive electrode active material with 10,000 times magnification wherein the image is taken at the center part of a secondary particle. Example of such image is shown in FIG. 2a wherein the dotted line shows the area to be captured corresponding to FIG. 2b.
Step 2) Set scale according to the SEM magnification.
Step 3) Draw lines following primary particle edges using ‘polygon selections’ tool for at least 50 particles. The particles at the edges of image are to be excluded if truncated.
Step 4) Measure the area of the drawn primary particles selected from Set Measurements and Area box.
Step 5) Calculated the particle diameter of each measured area by assuming the particle in the spherical shape following

$$d = 2 \times \sqrt{\frac{area}{π}}$$

and obtain the average primary particle diameter for at least 50 particles.

### E) Carbon Analysis

The content of carbon of the positive electrode active material powder is measured by Horiba Emia-Expert carbon/sulfur analyzer. 1 gram of the positive electrode active material powder is placed in a ceramic crucible in a high frequency induction furnace. 1.5 grams of tungsten and 0.2 grams of tin are added into the crucible as accelerators. The powder is heated at a programmable temperature wherein gases produced during the combustion are then analyzed by Infrared detectors. The analysis of CO₂ and CO determines the carbon concentration.

### F) Sulfide Solid-State Rechargeable Battery Test

### F-1) Sulfide Solid-State Rechargeable Battery Preparation

### Positive Electrode Preparation:

For the preparation of a positive electrode, a slurry contains positive electrode active material powder, Li—P—S based solid electrolyte, carbon (Super-P, Timcal), and binder (RC-10, Arkema)—with a formulation of 64.0:30.0:3.0:3.0 by weight—in butyl acetate solvent is mixed in Ar-filled glove box. The slurry is casted on one side of an aluminum foil followed by drying the slurry coated foil in a vacuum oven to obtain a positive electrode. The obtained positive electrode is punched with a diameter of 10 nm wherein the active material loading amount is around 4 mg/cm².

### Negative Electrode Preparation:

For the preparation of a negative electrode, Li foil (diameter 3 mm, thickness 100 μm) is placed centered on the top of In foil (diameter 10 nm, thickness 100 μm) and pressed to form Li—In alloy negative electrode.

### Separator Preparation:

For the preparation of a separator which also has a function of the solid electrolyte in a battery, the Li—P—S based solid electrolyte is pelletized with a pressure of 250 MPa to obtain 100 μm pellet thickness.

### Cell Assembly:

A sulfide solid-state rechargeable battery is assembled in an Ar-filled glovebox with such order from bottom to top: positive electrode comprising Al current collector with the coated part on the top-separator-negative electrode with Li side on the top-Cu current collector. The stacked components are pressed together with a pressure of 250 MPa and placed in an external cage to prevent air exposure.

### F-2) Testing Method

The testing method is a conventional “constant cut-off voltage” test. The conventional cell test in the present invention follows the schedule shown in Table 2. Each cell is cycled at 60° C. using a Toscat-3100 computer-controlled galvanostatic cycling station (from Toyo).

The schedule uses a 1 C current definition of 160 mA/g. The initial charge capacity (CQ1) and discharge capacity (DQ1) are measured in constant current mode (CC) at C rate of 0.1 C in voltage range from 4.3 V to 2.5 V (Li/Li⁺) or from 3.7 V to 1.9 V (In—Li/Li⁺). The efficiency (%) of the reversible capacity is obtained according to an equation below:

$$Efficiency ( \% ) = \frac{D Q 1}{C Q 1} \times 100 ( \% ) .$$

The difference between the average voltage of the initial charge (CV1) and the average voltage of the initial discharge (DV1) is used to decide the amount of polarization of the positive electrode. To calculate CV1, a capacity in terms of power, in Watt-hours (Wh), is divided with CQ1. The capacity in terms of power of the discharge in the first cycle (W_{C1}) is calculated from the area beneath the plotted graph of voltage (V) versus capacity (mAh/g). DV1 is calculated by dividing the capacity in terms of power of the discharge in the first cycle (W_{D1}) with DQ1:

$$Polarization value ( mV ) = CV 1 ( mV ) - DV 1 ( mV ) .$$

TABLE 2
Cycling schedule for sulfide solid-state
rechargeable battery testing method

| | Charge | | | | Discharge | | | |
|---|---|---|---|---|---|---|---|---|
| | | End | | V/Li | | End | | V/Li |
| | C | current | Rest | metal | C | current | Rest | metal |
| Cycle | Rate | (C) | (min) | (V) | Rate | (C) | (min) | (V) |
| 1 | 0.1 | — | 10 | 4.3 | 0.1 | — | 10 | 2.5 |
| 2 | 0.2 | 0.05 | 10 | 4.3 | 0.2 | — | 10 | 2.5 |
| 3 | 0.2 | 0.05 | 10 | 4.3 | 0.33 | — | 10 | 2.5 |
| 4 | 0.2 | 0.05 | 10 | 4.3 | 0.5 | — | 10 | 2.5 |
| 5 | 0.2 | 0.05 | 10 | 4.3 | 1.0 | — | 10 | 2.5 |
| 6~11 | 0.2 | 0.05 | 10 | 4.3 | 0.2 | — | 10 | 2.5 |
| 12 | 0.1 | — | 10 | 4.3 | 0.1 | — | 10 | 2.5 |

The present invention is further illustrated in the following examples.

### Comparative Example 1

A positive electrode active material CEX1 is obtained through following steps:
1) Preparing a mixture: 100.0 grams of Ni_{0.625}Mn_{0.175}Co_{0.200}(OH)₂ and 26.8 grams of LiOH are mixed homogeneously to obtain a mixture.
2) Heating: The mixture obtained from step 1) is heated at 830° C. for 10 hours while dry air flowing and cooled to room temperature so as to obtain a positive electrode active material CEX1.

### Example 1.1

A positive electrode active material EX1.1 is obtained through following steps:
1) Preparing a first mixture: 100.0 grams of Ni_{0.625}Mn_{0.175}Co_{0.200}(OH)₂ and 26.8 grams of LiOH are mixed homogeneously to obtain a first mixture.
2) First heating: The first mixture obtained from step 1) is heated at 830° C. for 10 hours while dry air flowing and cooled to room temperature.
3) Preparing a second mixture: 50.0 grams of the first heated material obtained from step 2) and 0.14 grams of H₃BO₃ are mixed homogeneously to obtain a second mixture.
4) Second heating: The second mixture obtained from step 3) is heated at 350° C. for 7 hours under O₂ atmosphere. The second heated material is cooled to room temperature, crushed, and sieved so as to obtain a positive electrode active material EX1.1.

### Example 1.2

A positive electrode active material EX1.2 is prepared according to the same method as EX1.1 except that 0.27 grams of H₃BO₃ is used in Step 3).

### Comparative Example 2

A positive electrode active material CEX2 is prepared according to the same method as CEX1 except that Step 2) is conducted at 860° C. for 10 hours.

### Example 2.1

A positive electrode active material EX2.1 is prepared according to the same method as EX1.1 except that Step 2) is conducted at 860° C. for 10 hours.

### Example 2.2

A positive electrode active material EX2.2 is prepared according to the same method as EX1.1 except that Step 2) is conducted at 860° C. for 10 hours and 0.27 grams of H₃BO₃ is used in Step 3).

### Comparative Example 3.1

A positive electrode active material CEX3.1 is obtained through following steps:
1) Preparing a mixture: 100.00 grams of Ni_{0.92}Mn_{0.03}Co_{0.05}(OH)₂ and 25.34 grams of anhydrous LiOH are mixed homogeneously to obtain a mixture.
2) Heating: The mixture prepared from step 1) is heated at 750° C. for 10 hours under O₂ atmosphere and cooled to room temperature so as to obtain a positive electrode active material CEX3.1.

### Comparative Example 3.2

A positive electrode active material CEX3.2 is obtained through following steps:
1) Preparing a first mixture: 100.00 grams of Ni_{0.92}Mn_{0.03}Co_{0.05}(OH)₂ and 25.34 grams of anhydrous LiOH are mixed homogeneously to obtain a first mixture.
2) First heating: The first mixture obtained from step 1) is heated at 750° C. for 10 hours under O₂ atmosphere and cooled to room temperature.
3) Preparing a second mixture: 100.00 grams of the first heated material obtained from step 2) and 0.37 grams of H₃BO₃ are mixed homogeneously to obtain a second mixture.
4) Second heating: The second mixture obtained from step 3) is heated at 350° C. for 6 hours under O₂ atmosphere. The second heated material is cooled to room temperature, crushed, and sieved so as to obtain a positive electrode active material CEX3.2.

### Example 4

A positive electrode active material CEX4 is obtained through following steps:
1) Preparing a first mixture: 100.00 grams of Ni_{0.625}Mn_{0.175}Co_{0.200}(OH)₂ and 26.8 grams of LiOH are mixed homogeneously to obtain a first mixture.
2) First heating: The first mixture obtained from step 1) is heated at 830° C. for 10 hours while dry air flowing and cooled to room temperature.
3) Preparing a second mixture: 100.0 grams of the first heated material obtained from step 2) and 1.14 grams of H₃BO₃ are mixed homogeneously to obtain a second mixture.
4) Second heating: The second mixture obtained from step 3) is heated at 350° C. for 6 hours under dry air flowing atmosphere. The second heated material is cooled to room temperature, crushed, and sieved so as to obtain a positive electrode active material CEX4.

### Comparative Example 5

A positive electrode active material CEX5 is obtained through following steps:
1) Preparing a first mixture: 100.00 grams of Ni_{0.625}Mn_{0.175}Co_{0.200}(OH)₂, 0.38 grams of H₃BO₃, and 26.63 grams of LiOH are mixed homogeneously to obtain a first mixture.
2) Heating: The mixture obtained from step 1) is heated at 830° C. for 10 hours while dry air flowing and cooled to room temperature. The heated material is cooled to room temperature, crushed, and sieved so as to obtain a positive electrode active material CEX5.

TABLE 3
A summary of the chemical composition, B_{B}/B_{A}
ratio and average primary particle diameter

| | | | | | | | | Average | |
|---|---|---|---|---|---|---|---|---|---|
| | Composition* (mol %) | | | | | | | primary | |
| | from ICP-OES | | | | | | | particle | |
| Example | Ni | Co | Mn | B | | | C | diameter | D50 |
| ID | (x) | (y) | (z) | (b) | B_{B}** | B_{B}/B_{A}*** | (ppm) | (nm) | (μm) |
| CEX1 | 64.3 | 19.5 | 16.2 | 0.00 | n/a**** | n/a | 104 | 274 | 9.89 |
| EX1.1 | 64.8 | 19.4 | 15.4 | 0.43 | 0.47 | 109.6 | 202 | 292 | 11.00 |
| EX1.2 | 63.9 | 19.4 | 15.8 | 0.85 | 0.65 | 76.4 | 124 | 274 | 10.00 |
| CEX2 | 63.8 | 19.7 | 16.5 | 0.00 | n/a | n/a | 180 | 312 | 10.20 |
| EX2.1 | 63.6 | 19.7 | 16.3 | 0.47 | 0.46 | 97.1 | 147 | 312 | 10.10 |
| EX2.2 | 63.3 | 19.6 | 16.2 | 0.90 | 0.88 | 98.1 | 168 | 312 | 10.10 |
| CEX3.1 | 92.1 | 5.0 | 2.9 | 0.00 | n/a | n/a | 523 | 274 | 4.52 |
| CEX3.2 | 91.3 | 4.9 | 2.9 | 0.87 | 0.80 | 91.9 | 452 | 274 | 3.58 |
| EX4 | 63.1 | 19.4 | 15.8 | 1.74 | 1.00 | 58.7 | 147 | 239 | 10.50 |
| CEX5 | 63.8 | 19.5 | 16.1 | 0.59 | 0.25 | 41.9 | 283 | 208 | 10.60 |

*Composition relative to total molar contents of Ni, Co, Mn, and B
**B_{B} is the molar fraction of B with respect to total molar contents of Ni, Co, Mn, and B analyzed by XPS
***B_{A} is the molar fraction of B with respect to total molar contents of Ni, Co, Mn, and B analyzed by ICP-OES
****n/a: not available

TABLE 4
A summary of the electrochemical properties

Electrochemical property

| | | | | Rate |
|---|---|---|---|---|
| Example | DQ1 | Efficiency | CV1-DV1 | efficiency |
| ID | (mAh/g) | (%) | (mV) | (%) |
| CEX1 | 189.5 | 91.0 | 57.7 | 77.1 |
| EX1.1 | 190.0 | 90.9 | 30.7 | 86.8 |
| EX1.2 | 195.0 | 95.1 | 30.1 | 90.6 |
| CEX2 | 180.2 | 85.0 | 19.2 | 83.1 |
| EX2.1 | 182.9 | 89.2 | 21.6 | 87.5 |
| EX2.2 | 182.4 | 89.0 | 30.3 | 85.4 |
| CEX3.1 | 207.7 | 88.6 | 133.8 | n/a* |
| CEX3.2 | 208.3 | 88.4 | 78.9 | 73.4 |
| EX4 | 185.1 | 93.8 | 77.8 | 85.9 |
| CEX5 | 155.5 | 79.3 | 98.8 | 87.4 |

*n/a: not applicable

Table 3 summarizes the chemical compositions, B_{B}/B_{A} ratios, average primary particle diameters and average secondary particle diameters. Table 4 summarizes the electrochemical properties such as DQ1, efficiency, polarization (CV1-DV1) and rate efficiency for the examples and the comparative examples.

The average primary particle diameters of CEX1, EX1.1, and EX1.2 are smaller than the average primary particle diameters of CEX2, EX2.1, and EX2.2, wherein the average primary particle diameters are between 270 nm and 300 nm for CEX1, EX1.1, and EX1.2 and the average primary particle diameters are 312 nm for CEX2, EX2.1, and EX2.2. The SEM image of CEX1 is shown in FIG. 2a as the representative. The image of FIG. 2b contains drawn lines and number to identify primary particle in order to obtain the average primary particle diameter. The solid-state rechargeable battery comprising CEX1, EX1.1, or EX1.2 has the higher DQ1 than the battery comprising CEX2, EX2.1, or EX2.2, wherein CEX1, EX1.1, and EX1.2 have the smaller primary particle size than CEX2, EX2.1, and EX2.2.

In Table 3, the XPS analysis results of B (B_{B}) are compared with the ICP-OES results of B (B_{A}) for EX1.1, EX1.2, EX2.1, and EX2.2. The B_{B} result higher than 0 indicates that said B is present on the surface of the positive electrode active material as associated with the XPS measurement whose signal is acquired from the first few nanometers (e.g. 1 nm to 10 nm) of the uppermost part of a sample. On the other hand, B_{A} from ICP-OES measurement is the B content of the entire particle. Therefore, the ratio of XPS result to ICP-OES result such as B_{B}/B_{A} higher than 1 indicates that said B is present mostly on the surface of the positive electrode active material. The higher B_{B}/B_{A} value corresponds with the more B presence on the surface of positive electrode active material. The representative of XPS spectra showing B1s peak of EX1.1 is in FIG. 1.

The positive electrode active materials EX1.1 and EX1.2 comprise 0.43 mol % B and 0.85 mol % B, respectively, with respect to total molar contents of Ni, Co, Mn, and B. The B_{B}/B_{A} value of EX1.1 is 109.6 and that of EX1.2 is 76.4, which confirms the B presence on the surface of the particle according to this invention. The solid-state rechargeable battery comprising EX1.1 has a DQ1 value of 190.0 mAh/g, higher than the DQ1 value of the battery comprising CEX1. The battery comprising EX1.2 which comprises the higher B molar content has the largest DQ1 value of 195.0 mAh/g among CEX1, EX1.1, and EX1.2. Besides, the battery comprising EX1.1 or EX1.2 respectively shows the improved rate efficiency comparing to the battery comprising CEX1, which indicates the improved electrochemical stability. The positive electrode active materials EX2.1 and EX2.2 comprise 0.47 mol % B and 0.90 mol % B respectively, with respect to total molar contents of Ni, Co, Mn, and B. It is observed that the solid-state rechargeable battery comprising EX2.1 or EX2.2 has a higher DQ1 value and improved rate efficiency comparing to the battery comprising CEX2, wherein the B_{B}/B_{A} value of EX2.1 is 97.1 and that of EX2.2 is 98.1 indicating the B presence on the surface of the particle.

The positive electrode active material CEX3.2 has B_{B}/B_{A} value of 91.9, which indicates the B presence on the surface of the particle while CEX3.1 does not comprise B on the surface of the particle. The solid-state rechargeable battery comprising EX1.1, EX1.2, EX2.1 or EX2.2 has an improved efficiency and CV1-DV1 as compared to the battery comprising CEX3.2. It is observed that the positive electrode material comprising Ni in a range from 50.0 mol % to 75.0 mol % with respect to the total amount of Ni, Co, Mn, B, and Q according to this invention can provide an obviously improved DQ1 and/or an improved CV1-DV1 and/or an improved efficiency of reversible capacity.

The positive electrode active material EX4 and CEX5 comprise 1.74 mol % of B and 0.59 mol % of B respectively, relative to total molar contents of Ni, Co, Mn, and B, which EX4 has B_{B}/B_{A} value of 58.7 and CEX5 has B_{B}/B_{A} value of 41.9. The average primary particle diameters of EX4 and CEX5 are 239 nm and 208 nm respectively, calculated by analyzing the SEM image. The solid-state rechargeable battery comprising CEX5 has an apparently low DQ1 comparing to the battery comprising EX1.1 or EX1.2, and both the efficiency and the polarization value, CV1-DV1, are more improved with the battery comprising EX1.1 or EX1.2. It suggests that a solid-state rechargeable comprising a positive electrode active material comprising B with B_{B}/B_{A} value higher than 43.0 has the improved electrochemical properties.

Furthermore, it is obviously observed that the combination of average primary particle diameter in the range of 100 nm to 400 nm and B_{B}/B_{A} higher than 40.0, preferably higher than 45.0, more preferably higher than 50.0, can achieve the objective of the present invention, which is to provide a positive electrode active material having an improved DQ1 and an improved rate efficiency.

1-17. (canceled)

18. A positive electrode active material for solid state batteries comprising Li, M′, and oxygen, wherein M′ comprises:
Ni in a content x, wherein 50.0≤x≤75.0 mol %, relative to M′,
Co in a content y, wherein 0.0≤y≤30.0 mol %, relative to M′,
Mn in a content z, wherein 0.0≤z≤30.0 mol %, relative to M′,
B in a content b, wherein 0.01≤b≤2.0 mol %, relative to M′,
Q in a content q, wherein Q is an element other than Li, O, Ni, Co, Mn and B, wherein 0.0≤q≤2.0 mol %, relative to M′, and,
wherein x, y, z, b, and q are measured by ICP-OES,
wherein x+y+z+b+q is 100.0 mol %,
wherein the positive electrode active material has a B content B_{A} defined as b/(x+y+z+b),
wherein the positive electrode active material has a B content B_{B} wherein B_{B} is determined by XPS analysis, wherein B_{B} is expressed as molar fraction B compared to the sum of molar fractions of Ni, Mn, Co, and B, as measured by XPS analysis, wherein the ratio B_{B}/B_{A}>45.0,
wherein said positive electrode active material comprises secondary particles comprising a plurality of primary particles, and
wherein said primary particles have an average diameter of between 100 nm to 400 nm as determined by measuring primary particle size in an image taken by SEM.

19. The positive electrode active material according to claim 18, wherein the ratio B_{B}/B_{A} is >50.0.

20. The positive electrode active material according to claim 18, wherein the ratio B_{B}/B_{A} is <1000.0.

21. The positive electrode active material according to claim 18, wherein x≥55.0 mol %.

22. The positive electrode active material according to claim 18, wherein x≤70.0 mol %.

23. The positive electrode active material according to claim 18, wherein Co is in a content 0.0 mol %<y≤28.0 mol %.

24. The positive electrode active material according to claim 18, wherein Mn is in a content 0.0 mol %<z≤28.0 mol %.

25. The positive electrode active material according to claim 18, wherein 0.01 mol %≤b≤1.5 mol %.

26. The positive electrode active material according to claim 18, wherein the secondary particle median size D50 is between 12 and 20 mm, as determined by laser diffraction particle size analysis.

27. The positive electrode active material according to claim 18, wherein said primary particles have an average diameter of between 150 and 375 nm.

28. The positive electrode active material according to claim 18, having a Li/M′ ratio (mol/mol) in a range of 0.90-1.10.

29. The positive electrode active material according to claim 18, wherein Q is at least one element selected from the group consisting of Al, Ti, Ba, Ca, Cr, Fe, Mg, Mo, Nb, S, Si, Sr, V, W, Y, Zn, and Zr.

30. A method for manufacturing a positive electrode active material for solid state batteries according to claim 18, comprising the consecutive steps of:
preparing a lithium transition metal-based oxide compound,
mixing said lithium transition metal-based oxide compound with a B source so as to obtain a mixture, and
heating the mixture at a temperature between 250° C. and less than 500° C. for a time between 1 hour and 20 hours so as to obtain the positive electrode active material powder.

31. The method according to claim 30, wherein heating of the mixture is under an oxidizing atmosphere.

32. A solid-state battery comprising the positive electrode active material according to claim 18.

33. The solid-state battery according to claim 32, wherein said solid state battery comprises a sulfide based solid electrolyte.

34. A portable computer, a tablet, a mobile phone, an energy storage system, an electric vehicle, or a hybrid electric vehicle comprising the solid-state battery according to claim 32.
